(19) United States
(12) Patent Application Publication
(10) Pub. No.: US 2018/0225807 A1
(43) Pub. Date: Aug. 9, 2018

(54) SINGLE-FRAME SUPER-RESOLUTION RECONSTRUCTION METHOD AND DEVICE BASED ON SPARSE DOMAIN RECONSTRUCTION

(71) Applicant: Shenzhen China Star Optoelectronics Technology Co., Ltd., Shenzhen, Guangdong (CN)

(72) Inventors: Jih-shiang LEE, Shenzhen, Guangdong (CN); Shensian SYU, Shenzhen, Guangdong (CN); Ming-jong JOU, Shenzhen, Guangdong (CN)

(73) Assignee: Shenzhen China Star Optoelectronics Technology Co., Ltd., Shenzhen, Guangdong (CN)

(21) Appl. No.: 15/504,503

(22) PCT Filed: Jan. 17, 2017
(86) PCT No.: PCT/CN2017/071334

§ 371 Date: Feb. 16, 2017

(30) Foreign Application Priority Data
Dec. 28, 2016 (CN) 201611237470.5

(51) Int. Cl. G06T 3/40

(52) U.S. Cl. CPC G06T 3/4076; G06T 2207/20224; G06T 3/4007

(57) ABSTRACT

The disclosure relates to a method and a device for single frame super resolution reconstruction based on sparse domain reconstruction, The disclosure mainly solves the technical problem in the prior art that the reconstructed image with high quality cannot be obtained by selecting the appropriate interpolation function according to the prior knowledge of the image. The disclosure adopts the first paradigm of the example mapping learning to train the mapping M of the low resolution feature on the sparse domain Bₗ to the high resolution feature on the sparse domain Bₕ and the mapping of the high resolution feature on the sparse domain Bₕ to the high resolution feature Y_{S}, equalizing the mapping error and the reconstruction error to the mapping operator M, the reconstructed high-resolution dictionary Φₕ and the reconstructed high-resolution sparse coefficient Bₕ, the better solution to the problem, can be used for graphics processing.

### FIELD OF THE DISCLOSURE

The present disclosure relates to a graphics processing field, and more particularly to a single-frame super-resolution reconstruction method and a device based on sparse domain reconstruction.

### BACKGROUND OF THE DISCLOSURE

As a carrier of human world record, the image plays an important role in industrial production and daily life. However, due to the limitation of imaging system equipment condition, imaging environment and limited network data transmission bandwidth, the image process often has the motion blur, the down sampling and the noise pollution and so on the degradation process, so that the actual obtainment image resolution is low, the detail texture loss, the subjective visual effect is not good. In order to obtain high-resolution images with clear texture and rich detail, the most direct and effective method is to improve the physical resolution level of sensor device and optical imaging system by improving the manufacturing process, however, the high price and complexity of the improvement process seriously limits the development prospects of such technology. To this end, we need a low-cost, outstanding reconstruction method to enhance the resolution of the image, without additional hardware support to minimize the case of fuzzy and noise and other external environment interference, in the existing process of manufacturing conditions to obtain high-quality images. The image super-resolution reconstruction refers to the use of one or more low-resolution images, through signal processing technology to obtain a clear high-resolution images. This technology can effectively overcome the inherent resolution of imaging equipment, break through the limitations of the imaging environment, without changing the existing imaging system under the premise, quality images above the physical resolution of the imaging system can be obtained at the lowest cost.

The prior art is based on an interpolation method. The method first determines the pixel value of the corresponding low-resolution image on the reconstructed image according to the magnification, and then estimates the unknown pixel value on the reconstructed image grid using the determined interpolation kernel function or the adaptive interpolation kernel function. This method is simple and efficient and has low computational complexity. However, it is difficult to obtain high-quality reconstructed images by choosing the appropriate interpolation function according to the prior knowledge of the image, the essential reason for this is that interpolation based methods do not increase the amount of reconstructed image information as compared to lower resolution images. Therefore, it is necessary to provide a single-frame image super-resolution reconstruction algorithm based on sparse domain reconstruction, which can obtain high-quality reconstructed images based on prior knowledge of image selection and appropriate interpolation function.

### SUMMARY OF THE DISCLOSURE

The technical problem to be solved by the present disclosure is that there is a technical problem in the prior art that the reconstructed image of high quality cannot be obtained by selecting the appropriate interpolation function according to prior knowledge of the image, the present disclosure provides a reconstruction algorithm which can obtain high-quality reconstructed image by selecting appropriate interpolation function according to the prior knowledge of the image.

In order to solve the above technical problems, the technical scheme adopted by the disclosure is as follows:

A single-frame super-resolution reconstruction method based on sparse domain reconstruction, wherein; the method includes:

(1) a training phase:

the training phase is a mapping model for learning a low-resolution image on a training data set to obtain a corresponding high-resolution image, including:

(A) establishing a low-resolution feature set according to the low-resolution graph and establishing a high-resolution feature set according to the high-resolution graph;

(B) solving the dictionary and sparse coding coefficients corresponding to the low resolution feature according to the K-SVD method;

(C) establishing the objective equation of the sparse domain reconstruction;

(D) according to the quadratic constrained quadratic programming algorithm, the sparse coding algorithm and the ridge regression algorithm are alternately optimizing and iteratively solving when the variation is smaller than the threshold; the high resolution dictionary, the high resolution sparse coding coefficient and the sparse mapping matrix are obtained;

(2) a synthesis stage:

the synthesis stage applies the learned mapping model to the input low-resolution image to synthesize the high-resolution image, including:

(a) extracting features from the resolution pattern;

(b) obtaining the sparse coding coefficients using the OMP algorithm on the dictionary obtained by the low resolution feature in the training phase;

(c) applying the low resolution coding coefficients obtained in the training phase to a high resolution dictionary to synthesize high resolution features;

(d) fusing high-resolution features to obtain high-resolution images.

Wherein, the step (A) in the step (1) includes:

selecting the high resolution image database as the image training set I_{Y}^{S}={i_{Y}¹, . . . , i_{Y}^{p}, . . . , i_{Y}^{N}^{ₛ}}, the low resolution image set is I_{X}^{S}={i_{X}¹, . . . , i_{X}^{p}, . . . , i_{X}^{N}^{ₛ}};

the first-order gradient in the horizontal direction G_{X}, the first-order gradient in the vertical direction G_{Y}, the second-order gradient in the horizontal direction L_{X}, and the second order gradient in the vertical direction L_{Y}, respectively:

$${G}_{X} = [ 1 , 0 , - 1 ] , {G}_{Y} = {[ 1 , 0 , - 1 ]}^{T}$$

$${L}_{X} = \frac{1}{2} [ 1 , 0 , - 2 , 0 , - 1 ] , {L}_{Y} = {\frac{1}{2} [ 1 , 0 , - 2 , 0 , - 1 ]}^{T}$$

convoluting the low-resolution image training set I_{X}^{S} with the first-order gradient in the horizontal direction G_{X}, the first-order gradient in the vertical direction G_{Y}, the second-order gradient in the horizontal direction L_{X} and the second-order gradient in the vertical direction L_{Y}, respectively, obtaining the original low-resolution training set Z_{S}={zₛ¹, . . . , zₛⁱ, . . . , zₛ^{N}^{ₛₙ}};

after reducing the original low-resolution training set zₛ by PCA method, obtaining the projection matrix V_{pca} and low-resolution training set X_{S}={xₛ¹, . . . , xₛⁱ, . . . , xₛ^{N}^{ₛₙ}},

wherein, i_{Y}^{p} is the p high-resolution image, N^{s}, is the number of high-resolution images, i_{X}^{p} is the p low-resolution image, Nₛ is the number of low-resolution images; T is transpose operation; zₛⁱ is the i original low-resolution feature, Nₛₙ is the number of original low-resolution features; xₛⁱ is the i low-resolution feature, Nₛₙ is the number of low-resolution features.

Wherein, the step (B) in the step (1) includes:

obtaining the high-frequency image set by E^{S}={e¹, . . . , e^{p}, . . . , e^{N}^{ₛ}} by subtracting the high-resolution image training set I_{Y}^{S} from the corresponding low-resolution image training set I_{X}^{S};

using the unit matrix as the operator template, convoluting with the high frequency image set E^{S}, and obtaining the high resolution training set Y_{S}={yₛ¹, . . . , yₛⁱ, . . . , yₛ^{N}^{ₛₙ}}.

solving the low-resolution dictionary Φₗ and the sparse coding coefficients Bₗ corresponding to the low resolution feature X_{S} according to the K-SVD algorithm;

(Φₗ,Bₗ)=argmin_{{Φ}_{ₗ}_{,B}_{ₗ}_{}}∥X_{S}−ΦₗBₗ∥_{F}²+λₗ∥Bₗ∥₁

where e^{p} is the p high-frequency image, Nₛ is the number of high-frequency images; yₛⁱ is the i high-resolution feature, Nₛₙ is the number of high-resolution features; λₗ is the l₁ normalized coefficient of the norm optimization, ∥·∥_{F} is the F-norm and ∥·∥₁is the 1-norm.

Wherein, the step (C) in the step (1) includes:

solving the initial value of the high-resolution dictionary Φₕ₀ is solved according to the high-resolution feature training set Yₛ and the low-resolution characteristic coding coefficient Bₗ:

It is assumed that the low-resolution feature and the corresponding high-resolution feature respectively have the same coding coefficients on the low-resolution dictionary and the high-resolution dictionary, and based on the least-squares error:

Φₕ₀=Y_{S}Bₗ^{T}(BₗBₗ^{T})⁻¹

establishing the initial optimization objective formula for the sparse spanning domain and sparse domain mapping model of high resolution features:

min_{{Φ}_{ₕ}_{,B}_{ₕ}_{,M}}E_{D}(Y_{S},Φₕ,Bₕ)+α·E_{M}(Bₕ,MBₗ)

the sparseness of the high-resolution feature is that the error term E_{D} is: E_{D}(Y_{S},Φₕ,Bₕ)=∥Y_{S}−ΦₕBₕ∥_{F}²+β∥Bₕ∥₁

the sparse domain mapping error term E_{M} is:

$${E}_{M} ( {B}_{h} , {MB}_{l} ) = {‖ {B}_{h} - {MB}_{l} ‖}_{F}^{2} + \frac{γ}{α} {‖ M ‖}_{F}^{2}$$

obtaining the objective formula of the sparse domain reconstruction is:

min_{{Φ}_{ₕ}_{,B}_{ₕ}_{,M}}∥Y_{S}−ΦₕBₕ∥_{F}²+α∥Bₕ−MBₗ∥_{F}²+β∥Bₕ∥₁+γ∥M∥_{F}²,s.t.∥φ_{h,i}∥₂≤1,∀i

wherein, Bₗ is a low-resolution feature coding coefficient, Y_{S} is a high-resolution training set, T is a transpose operation of a matrix, and (·)⁻¹ is an inverse operation of a matrix; Y_{S} is a high-resolution training set, Φₕ is a high-resolution dictionary, Bₕ is a high-resolution feature coding coefficient, Bₗ is a low-resolution feature coding coefficient, M is a mapping matrix of the low-resolution feature coding coefficient to the high-resolution feature coefficient, E_{D} is the high-resolution feature sparse as the error term, E_{M} is the sparse domain mapping error term, and α is the mapping error term coefficient; is β is the l₁ normalized coefficient of the norm optimization, γ is the regular term coefficient of the mapping matrix; φ_{h,i} is the i atom of the high-resolution dictionary Φₕ.

Wherein, the step (D) in the step (1) includes:

iteratively solving the high-resolution dictionary Φₕ, the high-resolution feature coding coefficient Bₕ and the mapping matrix of the low-resolution characteristic coding coefficient to the high-resolution characteristic coding coefficient M according to the optimization target equation of the sparse domain reconstruction and the initial value Φₕ₀ of the high-resolution dictionary,

high-resolution feature coding coefficient Bₕ and mapping matrix M are fixed values, according to quadratic constrained quadratic programming method to solve high-resolution dictionary Φₕ:

min_{{Φ}_{ₕ}_{}}∥Y_{S}−ΦₕBₕ∥_{F}²,s.t.∥φ_{h,i}∥₂≤1,∀i

performing the sparse coding by min_{{B}_{ₕ}_{}}∥\tilde{Y}ₛ−\tilde{Φ}ₕBₕ∥_{F}²+β∥Bₕ∥₁ to solve the high resolution feature coding coefficient Bₕ;

$$\tilde{Y} = ( \begin{matrix}{Y}_{S} \\ \sqrt{α} {MB}_{l}\end{matrix} ) , {\tilde{Φ}}_{h} = ( \begin{matrix}{Φ}_{h} \\ \sqrt{α} \cdot E\end{matrix} )$$

according to the ridge regression optimization method, the mapping matrix of the iteration M^{(t)} is solved:

$${M}^{( t )} = ( 1 - μ ) {M}^{( t - 1 )} + μ {B}_{h} {{B}_{l}^{T} ( {B}_{l} {B}_{l}^{T} + \frac{γ}{α} I )}^{- 1}$$

obtaining a high-resolution dictionary Φₕ, a high-resolution sparse coding coefficient Bₕ and a sparse mapping matrix M when the amount of change of the optimization target value of the adjacent two-sparse domain reconstruction is smaller than the threshold;

where Φₕ₀ is an iterative initial value of a high-resolution dictionary, Bₕ₀=Bₗ is an iterative initial value of a high-resolution characteristic coding coefficient, M₀=E is an iterative initial value of a mapping matrix, E is the identity matrix, \tilde{Y} is the augmented matrix of the high resolution feature, Y_{S} is the high resolution training set, and \tilde{Φ}ₕ is the augmented matrix of the high resolution dictionary: α is the sparsity domain mapping error term coefficient, the value is 0.1, β is the L1 norm optimization regular term coefficient, the value is 0.01; μ is the iterative step size, α is the sparse domain mapping error term coefficient, γ is the mapping matrix regular term coefficient.

Wherein, the step (a) in the step (2) includes:

according to the low resolution image, processing the low-resolution images in the same training phase to obtain low-resolution test features X_{R}.

Wherein, the step (b) in the step (2) includes:

encoding the low resolution test feature X_{R} on the low resolution dictionary Φₗ obtained during the training phase using an orthogonal matching pursuit algorithm to obtain low resolution test feature coding coefficients B′ₗ.

Wherein, the step (c) in the step (2) includes:

using the low-resolution test feature coding coefficient B′ₗ as the projection matrix in the step (1) to obtain the high-resolution test characteristic coding coefficient B′ₕ;

obtaining the high-resolution test feature Y_{R} by multiplying the high-resolution dictionary Φₕ with the high-resolution test feature coding coefficient B′ₕ obtained in the training phase.

The present disclosure further discloses an apparatus for super-resolution reconstruction of a single frame image based on sparse domain reconstruction, wherein: the apparatus includes an extraction module connected in series, an operation module for numerical calculation, a storage module and a graphic output module;

the extraction module is used for extracting image features;

the storage module is used for storing data, including a single-chip microcomputer and an SD card, and the single-chip microcomputer is connected with the SD card for controlling the SD card to read and write;

the SD card is used for storing and transmitting data;

The graphic output module is used for outputting an image and comparing it with an input image, including a liquid crystal display and a printer.

Further, the extraction module includes an edge detection module, a noise filtering module and a graph segmentation module which are connected in turn;

the edge detection module is used for detecting the image edge feature;

the noise filtering module is used for filtering the noise in the image feature;

the image segmentation module is used for segmenting an image.

The disclosure adopts the first paradigm of the example mapping learning to train the mapping M of the low resolution feature on the sparse domain Bₗ to the high resolution feature on the sparse domain Bₕ and the mapping of the high resolution feature on the sparse domain Bₕ to the high resolution feature Yₛ, equalizing the mapping error and the reconstruction error to the mapping operator M, the reconstructed high-resolution dictionary Φₕ and the reconstructed high-resolution sparse coefficient Bₕ, avoiding a specific one because of the large error affects the reconstruction quality, so the mapping of the low-resolution feature to the high-resolution feature is described more accurately.

Advantageous effects of the disclosure:

1. improves the accuracy of mapping a low-resolution feature to a high-resolution feature;

2. to reduce the impact of reconstruction quality error value;

3. according to the prior knowledge of the image, choosing the appropriate interpolation function to obtain high quality reconstructed image.

### BRIEF DESCRIPTION OF THE DRAWINGS

FIG. 1 is a schematic view of the training phase of the method of the present disclosure;

FIG. 2 is a flow chart of the training phase of the method of the present disclosure;

FIG. 3 is a schematic view of the synthesis stage of the method of the disclosure;

FIG. 4 is a flow chart of the synthesis phase of the method of the present disclosure;

FIG. 5 is a block diagram showing the structure of the apparatus according to the present disclosure.

### DETAILED DESCRIPTION OF PREFERRED EMBODIMENTS

In order that the objects, technical solutions and advantages of the present disclosure will be more clearly understood, the present disclosure will be described in more detail with reference to the following examples. It is to be understood that the specific embodiments described herein are for the purpose of explaining the disclosure and are not intended to be limiting of the disclosure.

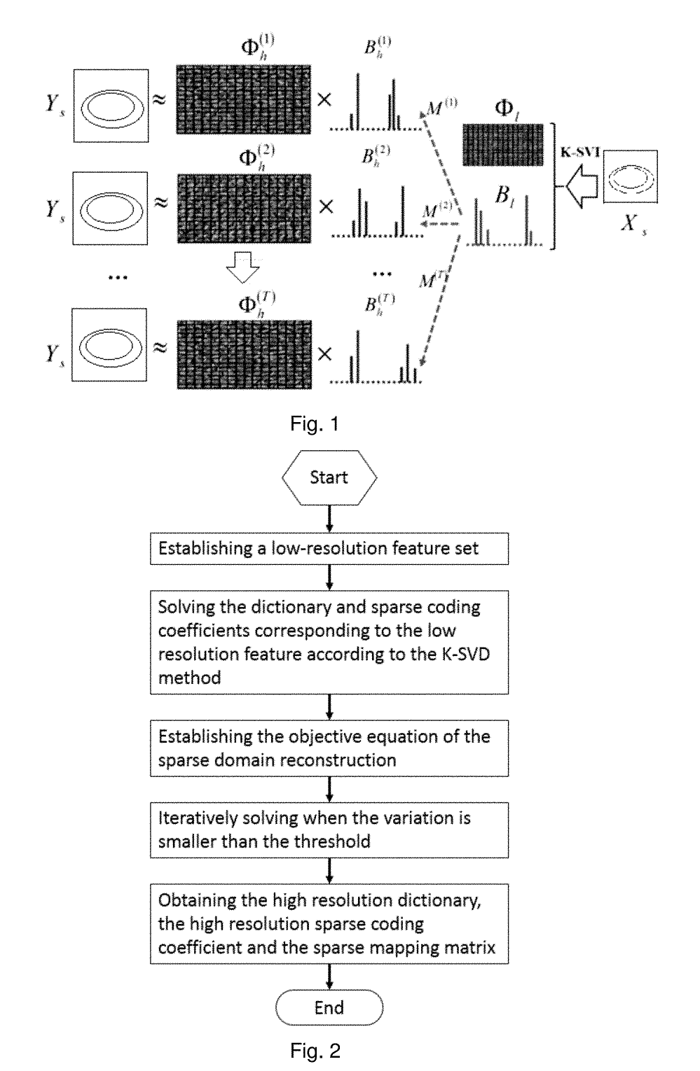

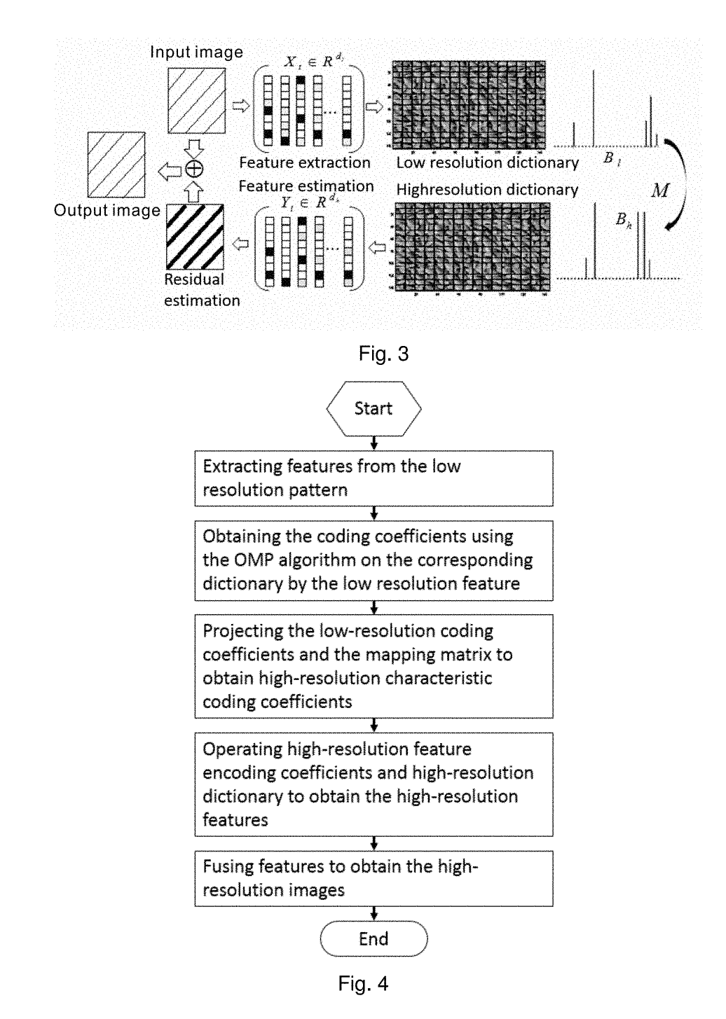

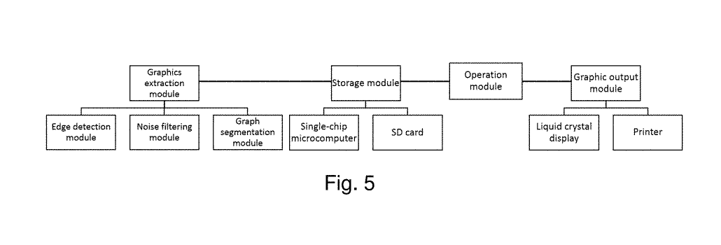

FIG. 1 is a schematic view of the training phase of the method of the present disclosure. FIG. 2 is a flow chart of the training phase of the method of the present disclosure. FIG. 3 is a schematic view of the synthesis stage of the method of the disclosure. FIG. 4 is a flow chart of the synthesis phase of the method of the present disclosure. FIG. 5 is a block diagram showing the structure of the apparatus according to the present disclosure.

### Embodiment 1

The present embodiment provides the apparatus shown in FIG. 5, including an extraction module, an operation module, a storage module and a graphic output module which are sequentially connected; the operation module is used for numerical calculation, the extraction module is used for extracting image features; the storage module is used for storing data, includes an 80C51 general-purpose type single-chip microcomputer and an SD card, the single-chip microcomputer is connected with an SD card for controlling the SD card to read and write; the SD card is used for storing and transmitting data; the graphic output module is used for outputting an image and comparing it with an input image, including a liquid crystal display and a printer. Wherein the extraction module includes an edge detection module, a noise filtering module and a graph segmentation module which are connected in turn; the edge detection module is used for detecting the image edge feature; the noise filtering module is used for filtering the noise in the image feature; the image segmentation module is used for segmenting an image.

The apparatus is applied to the method of the present embodiment, and the method is divided into a training phase and a synthesis stage. The algorithm training phase frame is shown in FIG. 1 and FIG. 2:

selecting a high-resolution image database with complex texture and geometric edges as the image training set I_{Y}^{S}={i_{Y}¹, . . . , i_{Y}^{p}, . . . , i_{Y}^{N}^{ₛ}}, where i_{Y}^{p} denotes the p high-resolution image and Nₛ denotes the number of high-resolution images. I_{X}^{S}={i_{X}¹, . . . , i_{X}^{p}, . . . , iₓ^{N}^{ₛ}}, is its corresponding low-resolution image set, where i_{X}^{p} denotes the p low-resolution image and N^{s} denotes the number of low-resolution images. According to the low-resolution image training set I_{X}^{S}, constructing a low-resolution training set X_{S}. The operator templates are defined as first order gradient in the horizontal direction G_{X}, first order in the vertical direction G_{Y}, second order in the horizontal direction L_{X} and second order in the vertical direction L_{Y}:

$${G}_{X} = [ 1 , 0 , - 1 ] , {G}_{Y} = {[ 1 , 0 , - 1 ]}^{T}$$

$${L}_{X} = \frac{1}{2} [ 1 , 0 , - 2 , 0 , - 1 ] , {L}_{Y} = {\frac{1}{2} [ 1 , 0 , - 2 , 0 , - 1 ]}^{T}$$

Wherein T denotes the transposition operation, respectively convolving the low-resolution image training set I_{X}^{S} with the first-order gradient in the horizontal direction G_{X}, the first-order gradient in the vertical direction G_{Y}, the second-order gradient in the horizontal direction L_{X} and the second-order gradient in the vertical direction L_{Y}, to obtain the training set of the original low-resolution feature Z_{S}={zₛ^{l}, . . . , zₛⁱ, . . . , zₛ^{N}^{ₛₙ}}; where zₛⁱ represents the i original low-resolution feature and Nₛₙ represents the number of original low-resolution features. After reducing the original low-resolution feature training set Z_{S} by PCA, obtaining the projection matrix V_{pca} and low-resolution feature training set X_{S}={xₛ^{l}, . . . , xₛⁱ, . . . , xₛ^{N}^{ₛₙ}}, xₛⁱ denotes the i low-resolution feature, and Nₛₙ denotes the number of low-resolution features. Next, the high-resolution image training set I_{Y}^{S} is subtracted from the corresponding low-resolution image training set I_{X}^{S} to obtain a high-frequency image set E^{S}={e¹, . . . , e^{p}, . . . , e^{N}^{ₛ}}, wherein e^{p} denotes the p high-frequency image, Nₛ denotes the number of high-frequency images; the unit matrix is used as the operator template, and performing the convolution operation with the high frequency image set E^{S} to obtain the high resolution training set Y_{S}={yₛ¹, . . . , yₛⁱ, . . . , yₛ^{N}^{ₛₙ}}; where yₛⁱ represents the i high resolution feature and Nₛₙ represents the number of high resolution features. According to the K-SVD algorithm, solving the low-resolution dictionary Φₗ and the sparse coding coefficient Bₗ corresponding to the low-resolution feature X_{S}

(Φₗ,Bₗ)=argmin_{{Φ}_{ₗ}_{,B}_{ₗ}_{}}∥X_{S}−ΦₗBₗ∥_{F}²+λₗ∥Bₗ∥ₗ

Wherein, λₗ denotes the regular term coefficient of l₁ norm optimization, ∥·∥_{F} denotes the F-norm, and ∥·∥₁ denotes the 1-norm. Solving the initial value of the high-resolution dictionary Φₕ₀ according to the high-resolution feature training set Y_{S} and the low-resolution characteristic coding coefficient Bₗ, it may be assumed that the low resolution feature and the corresponding high resolution feature have the same coding coefficients on the low resolution dictionary and the high resolution dictionary respectively, that is Bₕ=Bₗ, there is a coding relationship Φₕ₀Bₗ=Y_{S}, according to the least squared error can be obtained equation (3) shown below:

Φₕ₀=YₛBₗ^{T} (BₗBₗ^{T})⁻¹

wherein, Bₗ denotes the low-resolution feature coding coefficient, Y_{S} denotes the high-resolution feature training set, T denotes the transposition operation of the matrix, and (·)⁻¹ denotes the inverse operation of the matrix.

Then, an iterative algorithm is proposed to establish the optimal target formula for the sparse domain reconstruction. Firstly, the initial optimization objective formula is established for the sparse representation term and the sparse domain mapping model of the high resolution feature:

min_{{Φ}_{ₕ}_{,B}_{ₕ}_{,M}}E_{D}(Y_{S},Φₕ,Bₕ)+α·E_{M}(Bₕ,MBₗ)

wherein, Y_{S} is a high resolution feature training set, Φₕ is a high resolution dictionary, Bₕ is a high resolution feature coding coefficient, Bₗ is a low resolution feature coding coefficient, M is a mapping matrix of the low-resolution characteristic coding coefficients to the high-resolution characteristic coefficients, E_{D} is the sparse representation error term of the high resolution feature, E_{M} is the sparse domain mapping error term, and α is the mapping error term coefficient. The sparse representation error term of the high resolution feature E_{D} is further represented as equation (5):

E_{D}(Y_{S},Φₕ,Bₕ)=∥Y_{S}−ΦₕBₕ∥_{F}²+β∥Bₕ∥₁

wherein, β is the l¹ norm optimization regular term coefficient; the sparse domain mapping error term E_{M} is further expressed as

$${E}_{M} ( {B}_{h} , {MB}_{l} ) = {‖ {B}_{h} - {MB}_{l} ‖}_{F}^{2} + \frac{γ}{α} {‖ M ‖}_{F}^{2}$$

where γ is the regular term coefficient of the mapping matrix;

min_{{Φ}_{ₕ}_{,B}_{ₕ}_{,M}}∥Y_{S}−ΦₕBₕ∥_{F}²+α∥Bₕ−MBₗ∥_{F}²+β∥Bₕ∥₁+γ∥M∥_{F}²,s.t.∥φ_{h,i}∥₂≤1,∀i

the optimization target formula of the final sparse domain reconstruction;

wherein, φ_{h,i} represents the i atom of the high-resolution dictionary Φₕ. According to the objective formula of the sparse domain reconstruction and the initial value of the high resolution dictionary Φₕ₀, iteratively solving the high-resolution dictionary Φₕ, the high-resolution characteristic coding coefficient Bₕ, the mapping matrix of the low-resolution characteristic coding coefficient to the high-resolution characteristic coding coefficient M, specifically, the obtained Φₕ₀ is used as the iterative initial value of the high-resolution dictionary, setting the iterative initial value of the high-resolution feature coding coefficient is set to Bₕ₀=Bₗ, setting the iterative initial value of the mapping matrix to M₀=E, where E represents the identity matrix; fixed the high-resolution feature coding coefficients Bₕ and mapping matrix M, so that it remains unchanged, the use of quadratic constrained quadratic programming method for high-resolution dictionary Φₕ, get:

min_{{}_{ₕ}_{}}∥Y_{S}−ΦₕBₕ∥_{F}²,s.t.∥φ_{h,i}∥₂≤1,∀i

Fixed mapping matrix M and high-resolution dictionary Φₕ, for sparse coding

min_{{B}_{ₕ}_{}}∥\tilde{Y}ₛ−\tilde{Φ}ₕBₕ∥_{F}²+β∥Bₕ∥₁

Solving high—resolution feature coding coefficients Bₕ. Where \tilde{Y} denotes an augmented matrix of high-resolution features, Y_{S} denotes a high-resolution feature training set, and \tilde{Φ}ₕ denotes an augmented matrix of high-resolution dictionaries:

$$\tilde{Y} = ( \begin{matrix}{Y}_{S} \\ \sqrt{α} {MB}_{l}\end{matrix} ) , {\tilde{Φ}}_{h} = ( \begin{matrix}{Φ}_{h} \\ \sqrt{α} \cdot E\end{matrix} )$$

wherein, α is the coefficient of sparse domain mapping error term, which is 0.1, β is the coefficient of L1 norm optimization regular term, which is 0.01; Fixed high-resolution dictionary Φₕ and high-resolution feature encoding coefficients Bₕ, keep it constant, using the ridge regression optimization method to solve the t iteration of the mapping matrix M^{(t)}:

$${M}^{( t )} = ( 1 - μ ) {M}^{( t - 1 )} + μ {B}_{h} {{B}_{l}^{T} ( {B}_{l} {B}_{l}^{T} + \frac{γ}{α} I )}^{- 1}$$

where μ is the step size of the iteration, α is the sparse domain mapping error term coefficient, and γ is the regular term coefficient of the mapping matrix.

obtaining the final Φₕ,Bₕ and M by sequentially optimizing the iterations until the change of the optimization target value of the adjacent two sparse domain reconstructions is less than the threshold, and the training process of the super-resolution algorithm based on the sparse domain reconstruction is completed.

The synthesis stage framework of the present disclosure is shown in FIG. 3 and FIG. 4:

For the input low-resolution image, the same training phase of the image processing to get low-resolution test features X_{R}, encoding the low-resolution test feature X_{R} by the low-resolution dictionary Φₗ in the training phase, and obtaining the low-resolution test feature coding coefficient B′ₗ by the orthogonal matching pursuit algorithm, obtaining the coding coefficients of the low-resolution test feature B′ₗ and the mapping matrix M in the training phase, and obtaining the high-resolution test characteristic coding coefficient B′ₕ, multiplying the high-resolution dictionary Φₕ obtained by the training phase and the high-resolution test characteristic coding coefficient B′ₕ to obtain high-resolution test characteristics Y_{R}, finally, fusing the feature to obtain the high resolution image. Thus, all the steps of this embodiment are completed.

Although illustrative embodiments of the present disclosure have been described above in order to enable those skilled in the art to understand the present disclosure, the disclosure is not limited to the scope of the specific embodiments, it will be apparent to those skilled in the art that various changes in form and spirit may be made therein without departing from the spirit and scope of the disclosure as defined and defined in the appended claims.

What is claimed is:

1. A single-frame super-resolution reconstruction method based on sparse domain reconstruction, wherein; the method comprises:
(1) a training phase:
the training phase is a mapping model for learning a low-resolution image on a training data set to obtain a corresponding high-resolution image, comprising:
(A) establishing a low-resolution feature set according to the low-resolution graph and establishing a high-resolution feature set according to the high-resolution graph;(B) solving the dictionary and sparse coding coefficients corresponding to the low resolution feature according to the K-SVD method;
(C) establishing the objective equation of the sparse domain reconstruction;
(D) according to the quadratic constrained quadratic programming algorithm, the sparse coding algorithm and the ridge regression algorithm are alternately optimizing and iteratively solving when the variation is smaller than the threshold; the high resolution dictionary, the high resolution sparse coding coefficient and the sparse mapping matrix are obtained;
(2) a synthesis stage:
the synthesis stage applies the learned mapping model to the input low-resolution image to synthesize the high-resolution image, comprising:
(a) extracting features from the resolution pattern;(b) obtaining the sparse coding coefficients using the OMP algorithm on the dictionary obtained by the low resolution feature in the training phase;
(c) applying the low resolution coding coefficients obtained in the training phase to a high resolution dictionary to synthesize high resolution features;
(d) fusing high-resolution features to obtain high-resolution images.

2. The single-frame super-resolution reconstruction method based on sparse domain reconstruction according to claim 1, wherein, the step (A) in the step (1) comprises:
selecting the high resolution image database as the image training set I_{Y}^{S}={i_{Y}¹, . . . , i_{Y}^{p}, . . . , i_{Y}^{N}^{ₛ}}, the low resolution image set is I_{X}^{S}={i_{X}¹, . . . , i_{X}^{p}, . . . , i_{X}^{N}^{ₛ}};
the first-order gradient in the horizontal direction G_{X}, the first-order gradient in the vertical direction G_{Y}, the second-order gradient in the horizontal direction L_{X}, and the second order gradient in the vertical direction L_{Y}, respectively:
$${G}_{X} = [ 1 , 0 , - 1 ] , {G}_{Y} = {[ 1 , 0 , - 1 ]}^{T}$$
$${L}_{X} = \frac{1}{2} [ 1 , 0 , - 2 , 0 , - 1 ] , {L}_{Y} = {\frac{1}{2} [ 1 , 0 , - 2 , 0 , - 1 ]}^{T}$$
convoluting the low-resolution image training set I_{X}^{s} with the first-order gradient in the horizontal direction G_{X}, the first-order gradient in the vertical direction G_{Y}, the second-order gradient in the horizontal direction L_{X} and the second-order gradient in the vertical direction L_{Y}, respectively, obtaining the original low-resolution training set Z_{S}={zₛ¹, . . . , zₛⁱ, . . . , zₛ^{N}^{ₛₙ}};
after reducing the original low-resolution training set Zₛ by PCA method, obtaining the projection matrix V_{pca} and low-resolution training set X_{S}={xₛ¹, . . . , xₛⁱ, . . . , xₛ^{N}^{ₛₙ}},
wherein, i_{Y}^{p} is the p high-resolution image, Nₛ the number of high-resolution images, i_{X}^{p} is the p low-resolution image, N^{s} is the number of low-resolution images; T is transpose operation; zₛⁱ the i original low-resolution feature, Nₛₙ is the number of original low-resolution features; xₛⁱ is the i low-resolution feature, Nₛₙ is the number of low-resolution features.

3. The single-frame super-resolution reconstruction method based on sparse domain reconstruction according to claim 1, wherein, the step (B) in the step (1) comprises:
obtaining the high-frequency image set E^{S}={e¹, . . . , e^{p}, . . . , e^{N}^{ₛ}} by subtracting the high-resolution image training set I_{Y}^{S} from the corresponding low-resolution image training set I_{X}^{S};
using the unit matrix as the operator template, convoluting with the high frequency image set E^{S}, and obtaining the high resolution training set Y_{S}={yₛ¹, . . . , yₛⁱ, . . . , yₛ^{N}^{ₛₙ}};
solving the low-resolution dictionary Φₗ and the sparse coding coefficients Bₗ corresponding to the low resolution feature X_{S} according to the K-SVD algorithm;
(Φₗ,Bₗ)=argmin_{{Φ}_{ₗ}_{,B}_{ₗ}_{}}∥X_{S}−ΦₗBₗ∥_{F}²+λₗ∥Bₗ∥₁
where e^{p} is the p high-frequency image, N^{s} is the number of high-frequency images; yₛⁱ is the i high-resolution feature, Nₛₙ is the number of high-resolution features; λₗ is the l₁ normalized coefficient of the norm optimization, ∥·∥_{F} is the F-norm and ∥·∥₁ is the 1-norm.

4. The single-frame super-resolution reconstruction method based on sparse domain reconstruction according to claim 1, wherein, the step (C) in the step (1) comprises:
solving the initial value of the high-resolution dictionary Φₕ₀ is solved according to the high-resolution feature training set Yₛ and the low-resolution characteristic coding coefficient Bₗ:
It is assumed that the low-resolution feature and the corresponding high-resolution feature respectively have the same coding coefficients on the low-resolution dictionary and the high-resolution dictionary, and based on the least-squares error:
Φₕ₀=Y_{S}Bₗ^{T}(BₗBᵢ^{T})⁻¹
establishing the initial optimization objective formula for the sparse spanning domain and sparse doain mapping model of high resolution features:
min_{{Φ}_{,B}_{ₕ}_{,M}}E_{D}(Y_{S},Φₕ,Bₕ)+α·E_{M}(Bₕ,MBₗ)
the sparseness of the high-resolution feature is that the error term E_{D} is: E_{D}(Y_{S},Φₕ,Bₕ)=∥Y_{S}−ΦₕBₕ∥_{F}²+β∥Bₕ∥₁
the sparse domain mapping error term E_{M} is:
$${E}_{M} ( {B}_{h} , {MB}_{l} ) = {‖ {B}_{h} - {MB}_{l} ‖}_{F}^{2} + \frac{γ}{α} {‖ M ‖}_{F}^{2}$$
obtaining the objective formula of the sparse domain reconstruction is:
min_{{Φ}_{ₕ}_{,B}_{ₕ}_{,M}}∥Y_{S}−ΦₕBₕ∥_{F}²+α∥Bₕ−MBₗ∥_{F}²+β∥Bₕ∥₁+γ∥M∥_{F}²,s.t.∥φ_{h,i}∥₂≤1,∀i
wherein, Bₗ is a low-resolution feature coding coefficient, Y_{S} is a high-resolution training set, T is a transpose operation of a matrix, and (·)⁻¹ is an inverse operation of a matrix; Y_{S} is a high-resolution training set, Φₕ is a high-resolution dictionary, Bₕ is a high-resolution feature coding coefficient, Bₗ is a low-resolution feature coding coefficient, M is a mapping matrix of the low-resolution feature coding coefficient to the high-resolution feature coefficient, E_{D} is the high-resolution feature sparse as the error term, E_{M} is the sparse domain mapping error term, and α the mapping error term coefficient; β is the l₁ normalized coefficient of the norm optimization, γ is the regular term coefficient of the mapping matrix; φ_{h,i} is the i atom of the high-resolution dictionary Φₕ.

5. The single-frame super-resolution reconstruction method based on sparse domain reconstruction according to claim 1, wherein, the step (D) in the step (1) comprises:
iteratively solving the high-resolution dictionary Φₕ, the high-resolution feature coding coefficient Bₕ and the mapping matrix of the low-resolution characteristic coding coefficient to the high-resolution characteristic coding coefficient M according to the optimization target equation of the sparse domain reconstruction and the initial value Φₕ₀ of the high-resolution dictionary,
high-resolution feature coding coefficient Bₕ and mapping matrix M are fixed values, according to quadratic constrained quadratic programming method to solve high-resolution dictionary Φₕ:
min_{{Φ}_{ₕ}_{}}∥Y_{S}−ΦₕBᵢ∥_{F}²,s.t.∥φ_{h,i}∥₂≤1,∀i
performing the sparse coding by min_{{B}_{ₕ}_{}}∥\tilde{Y}ₛ−\tilde{Φ}ₕBₕ∥_{F}²+β∥Bₕ∥₁ to solve the high resolution feature coding coefficient Bₕ;
$$\tilde{Y} = ( \begin{matrix}{Y}_{S} \\ \sqrt{α} {MB}_{l}\end{matrix} ) , {\tilde{Φ}}_{h} = ( \begin{matrix}{Φ}_{h} \\ \sqrt{α} \cdot E\end{matrix} )$$
according to the ridge regression optimization method, the mapping matrix of the iteration M^{(t)} is solved:
$${M}^{( t )} = ( 1 - μ ) {M}^{( t - 1 )} + μ {B}_{h} {{B}_{l}^{T} ( {B}_{l} {B}_{l}^{T} + \frac{γ}{α} I )}^{- 1}$$
obtaining a high-resolution dictionary Φₕ, a high-resolution sparse coding coefficient Bₕ and a sparse mapping matrix M when the amount of change of the optimization target value of the adjacent two-sparse domain reconstruction is smaller than the threshold;
where Φₕ₀ is an iterative initial value of a high-resolution dictionary, Bₕ₀=Bₗ is an iterative initial value of a high-resolution characteristic coding coefficient, M₀=E is an iterative initial value of a mapping matrix, E is the identity matrix, \tilde{Y} is the augmented matrix of the high resolution feature, Y_{S} is the high resolution training set, and \tilde{Φ}ₕ is the augmented matrix of the high resolution dictionary: α is the sparsity domain mapping error term coefficient, the value is 0.1, β is the L1 norm optimization regular term coefficient, the value is 0.01; μ is the iterative step size, α is the sparse domain mapping error term coefficient, γ is the mapping matrix regular term coefficient.

6. The single-frame super-resolution reconstruction method based on sparse domain reconstruction according to claim 1, wherein, the step (a) in the step (2) comprises:
according to the low resolution image, processing the low-resolution images in the same training phase to obtain low-resolution test features X_{R}.

7. The single-frame super-resolution reconstruction method based on sparse domain reconstruction according to claim 1, wherein, the step (b) in the step (2) comprises:
encoding the low resolution test feature X_{R} on the low resolution dictionary Φₗ obtained during the training phase using an orthogonal matching pursuit algorithm to obtain low resolution test feature coding coefficients B′ₗ.

8. The single-frame super-resolution reconstruction method based on sparse domain reconstruction according to claim 1, wherein, the step (c) in the step (2) comprises:
using the low-resolution test feature coding coefficient B′ₗ as the projection matrix in the step (1) to obtain the high-resolution test characteristic coding coefficient B′ₕ;
obtaining the high-resolution test feature Y_{R} by multiplying the high-resolution dictionary Φₙ with the high-resolution test feature coding coefficient B′ₕ obtained in the training phase.

9. An apparatus for super-resolution reconstruction of a single frame image based on sparse domain reconstruction, wherein: the apparatus comprises an extraction module connected in series, an operation module for numerical calculation, a storage module and a graphic output module;
the extraction module is used for extracting image features;
the storage module is used for storing data, comprising a single-chip microcomputer and an SD card, and the single-chip microcomputer is connected with the SD card for controlling the SD card to read and write;
the SD card is used for storing and transmitting data;
The graphic output module is used for outputting an image and comparing it with an input image, comprising a liquid crystal display and a printer.

10. The apparatus for super-resolution reconstruction of a single frame image based on sparse domain reconstruction according to claim 9, wherein:
the extraction module comprises an edge detection module, a noise filtering module and a graph segmentation module which are connected in turn;
the edge detection module is used for detecting the image edge feature;
the noise filtering module is used for filtering the noise in the image feature;
the image segmentation module is used for segmenting an image.
